(19) United States
(12) Patent Application Publication
(10) Pub. No.: US 2008/0210027 A1
(43) Pub. Date: Sep. 4, 2008

(54) Motor-driven pivoting device for a support plate, especially the support plate of a motor vehicle mirror

(76) Inventors: Wilhelm Wolf, Petersaurach (DE); Josef Boegelein, Sachsen (DE); Wolfgang Seiboth, Bad Windsheim (DE); Heinrich Lang, Ergersheim (DE)

Correspondence Address: MCNAIR LAW FIRM, P.A., P.O. BOX 10827, GREENVILLE, SC, 29603-0827, US

(21) Appl. No.: 11/715,313

(22) Filed: Mar. 7, 2007

Related U.S. Application Data
(63) Continuation of application No. 10/471,557, filed on Feb. 11, 2004, now abandoned.

(51) Int. Cl. F16H 27/02

(52) U.S. Cl. 74/89

(57) ABSTRACT

The invention relates to a motor-driven pivoting device for a support plate that can cooperate with a positioning motor and be pivoted kinematically in relation to a holder, which is fixed to the object. In order to receive a mirror, the plate is provided with a fixed hollow spherical area on its rear side, which is directed away from the mirror, for stable mounting with a compact inbuilt part-turn actuator, mounted with the ability to pivot between two rigidly interconnected spherical surfaces along the generated surfaces thereof. The outer of the two interlocking spherical surfaces of the dual shell holder is embodied in the form of an assembly cap. Its inner surface is fitted out as a carrier for a device with a motor and a set of gears engaging with the gearing that moves radially to engage with the inner area of the device carrier along a generatrix of the inner generated surface of the hollow area.

### CROSS REFERENCES TO RELATED APPLICATION

This application is a continuation of U.S. application Ser. No. 10/471,557, filed Feb. 11, 2004, having the same title, and claiming priority from International Application No. PCT/EP01/02720, filed Mar. 12, 2001.

### BACKGROUND

The invention relates to a motor-driven pivoting device.

A pivoting device of this class is known in the art from WO 00/69683 in the construction type of a device carrier that is rigidly inserted in the—at that location semi-spherically shaped—outward bulge of the support plate the gear motor of which is engaged with a short toothing arc that extends diagonally relative to a generatrix of a spherical surface and that is movable along this generatrix. However, disadvantageously, this causes an unfavorable power flow, because the direction of the toothing engagement migrates along with the movement of the toothing arc. It is also disadvantageous that the device carrier with the mirror plate is pivoted relative to the holder, which is fixed in place, thereby jeopardizing the cable hook-ups for operating the gear motor and for other electrical functions (such as for position return reporting and for heating of the mirror surface). The movement of the semi-spherically shaped closed support plate outward bulge relative to the assembly cap that is fixed in place and receives the latter, is forcibly guided by way of interpositioning a shell that is radially locked via correspondingly extending ribs, on the one hand, with that on the inside of its pivotable outward bulge and, on the other hand, with that on the outside of its pivotable assembly cap. But all this requires considerable expense and effort to ensure the exact course of the guide grooves on both sides of the guide shell, still not preventing large frictional losses, in particular in connection with kinematically unfavorable spatial angle positions between support plate and assembly cap.

Less complex in terms of construction is, in contrast, an apparatus of another device carrier, also located on the inside of a, once again, semi-spherically shaped support plate outward bulge, but in this instance the device carrier has the ability to pivot relative to the former in accordance with WO 98/31565-A1 (corresponding to Schillegger et al. U.S. Pat. No. 6,174,062), which, simultaneously, also serves, through an opening in the hollow sphere, for the purpose of mounting the pivoting device to fix it to the device. Since the gear motor is radially engaged, through a slot in the device carrier, with a toothing along the inside jacket surface of the outward bulge, it is necessary to provide a three-dimensional support, in a diametrically opposed position, at the center of gravity below the center of the support plate by way of a limit of the device carrier in the shape of a hollow spherical section, which considerably restricts the allowable pivoting angle.

This construction principle was taken up and, in accordance with DE-200 17 163-U1 in combination with the DE-199 19 529-A1 (corresponding to Guttenberger et al. U.S. Pat. No. 6,341,536) that is cited in the former, further developed into a retaining strap solution which provides that two toothing straps, fastened cross-wise and elastically pre-loaded on the edge of the support plate, radially press the semi-spherically shaped device carrier, which is located therein with frictional contact, against the three-dimensional support at the center of gravity below the center of the support plate. This, however, reduces the guide surfaces essentially to the comparatively narrow strapping bands and does, therefore, not produce a security of construction that comes with having guide pairs with as large a surface as possible, which must be principally what is to be demanded.

A pivoting device of a completely different kind is known in the art from EP-0 316 055-A featuring the structural design of a housing for receiving a reversible electric small-power motor, respectively, for the coordinated driving of two tappet-like linear actuators that are moved in and out of the housing in opposite directions, respectively, relative to each other. This way, they cause a support plate to be pivoted around an axis, centrically, arranged diagonally in relation to the connecting line between the two linear actuators. The movement transfer from the motor to the linear actuator allocated to the former occurs respectively by way of the worm gear on the motor shaft which rotates a nut, that is axially arranged on the housing, by way of its external thread, thereby linearly displacing the actuator because the external thread of the actuator engages in the manner of a threaded bolt with the internal thread of the nut.

### SUMMARY OF THE INVENTION

The object of the present invention consists in designing a pivoting device of this same class providing for a more compact construction and less complexity due to individual components as well as providing for a sturdier construction. Simultaneously, the pivoting device shall be suitable—irrespective of the possibility of integrating electrical hook-ups for the pivoting motor—for further expansion into a system featuring two pivoting axes that are orthogonally arranged relative to each other.

According to the invention, this object is achieved by allowing for the possibility of creating a motor-driven wobbling motion on a spherical surface, as a large-surface support, for the support plate.

To this end, a hollow spherical area, which is axially asymmetrical with regard to its spherical center point (also to be referred to as hollow spherical layer), is equipped with the support plate in the plane of its larger axial cross-section that is arranged diagonally relative to the axis, i.e., that is arranged in this cross-sectional plane, in order to receive a mirror. The hollow spherical area, including the support plate, rests with the ability to pivot inside a dual shell holder that is fixed to the object.

The outer shell is a hood-shaped hollow spherical section (also to be referred to as hollow spherical segment), preferably with flattened outer pole area. Opposite to its opening, which receives the hollow spherical area in the rear of the plate, this outer hollow spherical section can be mounted as fixed to the object, preferably enclosing a flat electronic housing in the flattened pole area. From the vicinity of the internal crown area of this outer shell in the shape of a hollow spherical section, at least one base, which is rigidly fastened to the hollow spherical section, extends as far as the inside of the hollow spherical area where it supports the internal shell, which is also in the shape of a spherical area. Consequently, the support plate hollow spherical area rests, radially held in place, between the inside wall of the hollow spherical section (as the outer shell) and the outside wall of the central spherical area (as the inner shell), and it can be pivoted relative to them.

To effect a motor-driven pivoting action of the support plate hollow spherical area relative to the partial spheres that are resting, fixed to the object, inside each other, the inside wall on the support plate that is shaped like a hollow spherical area is realized with at least one toothed segment projecting in the shape of a rib along the hollow sphere generatrix into the inside of the sphere. The toothed segment radially engages with the central hollow spherical area, which serves as device carrier, in such a way that this toothed segment is kinematically engaged with a positioning motor that is arranged inside the device carrier. All that is needed now in order to effect pivoting in any desired direction is a second motor-driven toothed segment, arranged orthogonally relative to the initially referred to segment, on the hollow spherical area and comprising its own positioning motor inside the device carrier. Via triggering of the two motors inside the device carrier that is fixed to the object, it is possible to pivot the support plate relative to the partial spheres, which are fixed to the object, as the dual shell holder in all spatial directions. The stop limit acting upon this wobbling pivoting movement of the support plate relative to the dual shell axis, which is fixed to the object, depends solely on the axial construction heights of the partial spheres, because the hollow spherical area that is driven by its toothed segments is guided with the ability to pivot between the two partial spheres, fixed to the object, along their internal and external spherical surfaces. Since, in this context, the motors remain fixed to the object, the engagement of the teeth during the pivoting movement is ensured in such a way that the toothed segments are not hinged rigidly but, instead, orthogonally to the inside of the hollow spherical area relative to each other, respectively around a pivoting axis that is arranged radially with regard to the longitudinal axis, that is fixed to the object, which is why they always engage parallel in relation to the axis that is fixed to the object with the device carrier that is also fixed to the object.

Due to the large-surface support, this pivotable orientation of the spherical surface produces a higher level of stability that remains virtually even in connection with any spatial alignments, thus avoiding, in comparison to the conventional four-point or even only two-point bearing supports, undesired displacement or vibration of the support plate.

### BRIEF DESCRIPTION OF THE DRAWINGS

To illustrate the invention as well as its variations and further developments in more detail, we are referring to the following description of a preferred embodiment for providing a solution according to the invention that is represented approximately to scale in the drawing, while its functionality is only sketched in the abstract. Shown in the drawing from a slanted perspective are as follows:

FIG. 1: a dual shell holder that is to be mounted as fixed to the object comprising a hollow spherical section as its external shell, and a mirror support plate is positioned by way of a rear hollow spherical area in said shell and has the ability to pivot;

FIG. 2: a device carrier in the shape of a hollow spherical area suitable for receiving the motors of the pivoting drive of the plate, as an internal shell that can be coaxially connected, fixed to the object, to the external shell (FIG. 1) of the holder; and

FIG. 3: the support plate that is resting by its hollow spherical area on the device carrier, as compared to FIG. 1, shown with a removed external shell of the holder.

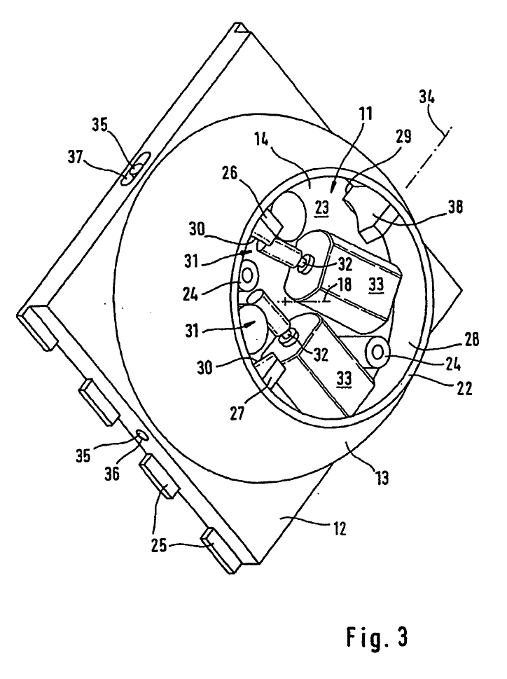

### DESCRIPTION OF A PREFERRED EMBODIMENT OF THE INVENTION

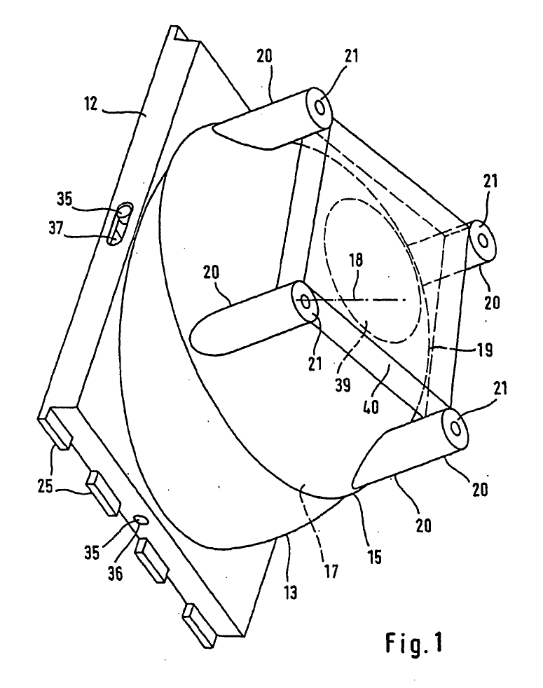

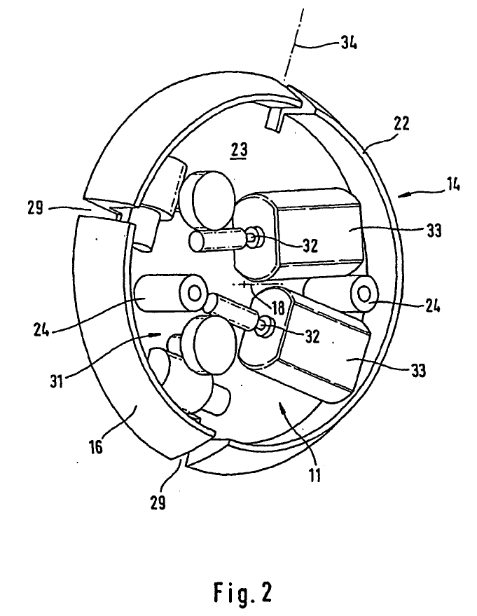

The kinematic motor-driven apparatus of the pivoting device 11 according to the invention (FIG. 2) for a support plate 12 (FIG. 1), for example, for the purpose of receiving a motor-driven adjustable vehicle rear view mirror is arranged on the inside of a spherical apparatus comprised of three shells 13, 14, 15. The middle shell of the apparatus is the hollow spherical area or bulge 13 that is offset eccentrically and with a parallel orientation relative to the equator. The middle shell is arranged between: (a) a device carrier 14, which is arranged inside it and also shaped in the form of a layer or hollow spherical area, and (b) an assembly cap 15, which is realized in the form of an outer shell shaped as a hollow spherical section of the holder. Thus, a spherically convex outer surface of the bulge 13 is slidable along a spherically concave surface of the assembly cap 15, and a spherically concave inner surface of the bulge is slidable along a spherically concave surface of the device carrier 14. In the interest of providing pivoting angles that are as large as possible, this dual shell area features a smaller axial height than the hollow spherical area 13 that is fixed on the support plate 12. Consequently, the hollow spherical area 13 that is positioned radially and with minimal friction between the device carrier 14, which is fixed relative to the supporting object (such as a vehicle body), and the related coaxial but axially offset assembly cap 15, which is fixed relative to the object, can thus be pivoted starting from the longitudinal axis 18, which is fixed relative to the object, into all directions on the external jacket surface 16 of the device carrier 14 and therefore, simultaneously, the internal jacket surface 17 of the assembly cap 15. This axis 18 follows a coaxial extension through the dual shell holder, i.e. through the device carrier 14 and assembly cap 15 of the latter.

For the stable mounting of the holder to an object, for example to the body of the driver's cabin of a motor vehicle, the hood-shaped assembly cap 15 is equipped with the axis-parallel pillars 20 on its outer pole area 39 that is flattened in its center area but generally features the essentially spherical cap-shaped external area 19. The free front ends 21 of the pillars are arranged in a mounting plane that is oriented, as sketched, diagonally relative to the longitudinal axis 18 through the crown of the assembly cap 15, if the axis 18 is to be arranged perpendicularly with regard to the mounting surface of the supporting object (for example, the body of a motor vehicle); but the mounting plane can also be pivoted relative to that axis 18.

The essentially spherically ring-shaped circumferential wall 22 of the flat, pot-shaped device carrier 14 is covered in the plane of its larger diameter by a floor 23. From this floor, axis-parallel bases 24 extend into the vicinity of the internal crown of the hollow, spherical, calotte-shaped assembly cap 15 in order to establish a rigid connection at this location between the device carrier 14 and the assembly cap 15 by way of radial clamping, with the ability to pivot, of the plate hollow spherical area 13, e.g. via locking action or via use of a straining screws through the bases 24 in order to fasten them to one another.

The hollow spherical area 13, which is arranged between the device carrier 14 and the assembly cap 15 and has the ability to pivot in any direction, features, in its turn, in the plane of its largest diameter with the support plate 12, radially extending said diameter, a hollow body that is flat and layer-shaped as well as open in the direction opposite to the holder 15. On its edge, the hollow body features tab-like projecting stop noses 25 for fastening the effective surface that is to be pivoted, which can, in particular, be a rear view mirror or a laser mirror. The sketch in the drawing does not show the integration of the a sliding contact on the side of the support plate 13 carrying the mirror for the purpose of an automatic hook-up of a resistance mirror heater since the plate is equipped with the mirror, correspondingly, without the need to provide any separate connecting clamps etc. for this purpose.

To externally effect the pivoting movement of the mirror carrier plate 12 relative to the dual shell holder, which is fixed to the object, the hollow spherical zone 13, positioned on the rear side of the support plate 12, is equipped with at least one arc segment 26, protruding essentially axis-parallel rib-shaped radially from its internal wall 28, and extending radially through an L-shaped slot 29 in the wall 22 and the floor 23 of the spherically shaped device carrier 14 into the hollow inside space of the latter. The arc segment 26 is directed with its inside arc through the device carrier 14, i.e. toward the center of the staggered hollow spherical apparatus and, therefore, also toward the longitudinal axis 18, and it is equipped with a toothing 30. The toothing is engaged via a multi-stage redirection and step-down set of gears 31, which rests on the floor 23 of the device carrier 14, with the exit shaft 32 of a high-speed extra-low voltage direct current motor 33, which is aligned as parallel relative to the floor 23, and is, therefore, arranged diagonally vis-vis the longitudinal axis 18, which is fixed to the object, but the exit shaft can be pivoted relative to the longitudinal axis. If the rotational movement of the motor displaces the arc segment 26, which is fastened inside the hollow spherical area 13 and toothed toward its inside arc, essentially parallel relative to the longitudinal axis 18, thereby causing the arc segment to plunge more or less deeply, parallel to the axis, into the inside of the device carrier 14, the hollow spherical area 13 is tipped between the device carrier 14 and the assembly cap 15 of the holder around a pivoting axis 34 that is principally radially aligned relative to the longitudinal axis 18 and that is aligned diagonally relative to the rib-shaped arc element 26, because, during this process, the arc segment performs a pivoting movement around said axis 34. For an orthogonal tipping movement of the carrier plate 12, an apparatus of the same kind is envisioned as well as the realization of another arc element 27 that is offset by 90. degree. along the circumference of the internal wall 28 relative to the first-mentioned wall, i.e. it intersects the pivoting axis 34 of the former in an orthogonal fashion.

To maintain the alignment of the arc segments 26, 27 with regard to the axis 18 that is fixed relative to the object and to thereby maintain the toothing engagement with regard to the respective gear 31 even when the hollow spherical zone 13 is tipped relative to the set of gears, each arc segment 26, 27 is positioned by way of a peg 35 around the pivoting axis 34 of the other arc segment 26, 27 inside the wall of the hollow spherical area 13 or, according to the sketch, the hollow support plate 12. When both tipping directions overlap one another, the pivoting axes 34 have the tendency, however, to twist around the longitudinal axis 18. In order to prevent this from causing a blockage of the pivoting of the hollow spherical area 13 and thereby leading to the false tipping of the support plate 12, at least one of the two pivoting pegs 35 for the arc segments 26, 27 is not positioned inside a round bore hole 36 and virtually without play, but it is positioned inside a longitudinal bore hole 37 that is aligned diagonally relative to the axes 18 and 34, i.e. it extends therefore in the plane of the pivoting axes 34, as can be seen in detail from FIG. 1 of the drawing. Consequently, in this plane, the pivoting peg 34 arranged therein is freely movable under the influence of the hollow spherical area 13 that is pivoted relative to the stationarily mounted axis 18, including the associated displacement of the related pivoting axis 34.

In addition to the two toothed arc segments 26, 27 for the motor-driven pivoting of the hollow spherical area 13 relative to the holder 15, which is fixed to the object, with its device carrier 14, it is suitable to envision at least one further arc-segment-shaped support element 38, the peg positioning of which is located, once again, in the hollow spherical area 12, coaxially relative to the pivoting axes 34, inside a round bore hole 36. This element 38 is not used for the motor-driven actuation but primarily for the purpose of supporting the hollow spherical area 13 and, therefore, its support plate 12 against any false tipping of the toothed arc segments 26, 27 away from the toothing engagement. Moreover, at the same time, this element 38 can suitably serve as a substrate for receiving a digital (coded or incremental) or analogue (potentiometric) angle transmitter, namely for the purpose of return reporting of the current alignment of the pivoted support plate 12 relative to the device carrier 14 that is fixed to the object.

The sketch outlining the principle at work in FIG. 1 further takes into account, in symbolically simplified form, that the mounting pillars 20 suitably project with their front ends 21 from a flattened outer pole area 39 of the outer spherical shell of the holder 15, which has the shape of a hollow spherical cap, far enough that a flat circuit housing 40 can be inserted between them. This flat housing 40 receives a board, always printed on one side (not visible in the sketch of the drawing), not requiring any follow-up work-up and serves with regard to the motor contact but, moreover, can be used to receive circuit components intended for a data bus for controlling and return reporting of the mirror position as well as, if necessary, additionally a potentiometer.

Consequently, according to the invention, in a motor-driven pivoting device 11 with a support plate 12, forming a kinematic effective connection with a positioning motor 33 that has the ability to pivot relative to a holder, which is fixed to the object, in particular for receiving a mirror, said plate 12 is irremovably equipped with a hollow spherical area 13 for the purpose of providing stable positioning in the presence of a compactly incorporated pivoting drive on the rear side located away from the mirror; and the hollow spherical area is arranged with the ability to pivot between the two spherical area surfaces of a dual shell holder, connected concentrically and rigidly to each other, in particular, along jacket surfaces of the latter that are directed toward each other. Of the two spherical surfaces that are rigidly positioned inside each other, the outer surface is arranged as an assembly cap 15 that resembles a hollow spherical segment, while the inner surface is realized as a flat, pot-like device carrier 14 that is equipped inside its spherical layer-shaped external jacket surface 16 with the motor 33 and the set of gears 31 and that engages with a toothing 30, arranged radially relative to the longitudinal axis of the system 18, which is fixed to the object, that engages with the interior space of the device carrier 14, along a generatrix of the inside jacket surface of the hollow spherical area 13.

What is claimed is:

1. Apparatus comprising:
a holder comprising an assembly cap connectable to a support object and forming an outwardly facing spherically concave surface;
a device carrier fixed to the holder and including an outwardly facing spherically convex surface arranged coaxially relative to the spherically concave surface, and a plurality of rotatable drive gearings disposed within a space encompassed by the spherically convex surface; and
a pivotable element comprising a support plate and a hollow spherical bulge connected to one side of the support plate, the spherical bulge positioned between the spherically concave surface and the spherically convex surface, wherein the spherical bulge includes a spherically concave inner surface slidably engaging the spherically convex surface of the device carrier, and a spherically convex outer surface slidably engaging the spherically concave surface of the holder, the pivotable element further including toothed elements mounted to the support plate and projecting into the space of the device carrier, each toothed element including a tooth arrangement operably connected to a respective drive gearing, wherein rotation of each drive gearing produces pivotal movement of the pivotable element about a respective axis.

2. The apparatus according to claim 1, wherein each toothed element is connected to the plate by a respective peg.

3. The apparatus according to claim 1 wherein the device carrier further comprises drive motors connected to respective drive gearings.

4. The apparatus according to claim 3 wherein there are at least two toothed elements arranged orthogonally relative to other and engaging respective toothed elements.

5. Apparatus according to claim 1 wherein the teeth are disposed relatively, on the inside of a rib-shaped arc segment positioned with the ability to pivot on the support plate by way of its peg along a pivoting axis of the other arc segment.

6. Apparatus according to claim 5 wherein a first peg is fastened in place with the ability to twist in a round bore hole in the support plate, while the second peg is aligned diagonally relative to the first peg and movably fastened in a longitudinal bore hole in the support plate that is located in the plane of the pivoting axes.

7. Apparatus according to claim 6 wherein at least diametrically across from one of the arc segments another arc segment radially engages within the device carrier as a non-driven support element.

8. Apparatus according to claim 7 wherein the support element also serves as a carrier for a position indicator with regard to the pivoting of the support plate relative to the device carrier that is fixed to the support object.

9. Apparatus according to claim 5, wherein at least one toothed arc segment that is flexibly arranged on the hollow spherical bulge extends radially away from the hollow spherical bulge and through an L-shaped slot formed in a floor and wall of the device carrier for toothed engagement with the respective drive gearing.

10. Apparatus according to claim 1 wherein the assembly cap forms a positive connection with the device carrier by bases that extend from a floor of the device carrier parallel in relation to the common axis of the holder and, the device carrier, the bases extending all the way into the vicinity of a crown area of the assembly cap.

11. Apparatus according to claim 1 wherein the assembly cap includes mounting pillars on an outside surface thereof.

12. Apparatus according to claim 11 wherein a flat housing with a circuit board is positioned between the mounting pillars behind a flattened outer pole area of the assembly cap.

13. Apparatus according to claim 1 wherein the support plate carries an electrical contact for connection to a resistance heater.
